(19) United States
(12) Patent Application Publication
(10) Pub. No.: US 2016/0027019 A1
(43) Pub. Date: Jan. 28, 2016

(54) SYSTEMS AND METHODS FOR GENERATING WORKFLOW REPORTS

(71) Applicant: Yonyx, Inc., Sunnyvale, CA (US)

(72) Inventors: Nixon Michaelangelo, Bangalore (IN); Sanjay Bajaj, Saratoga, CA (US)

(21) Appl. No.: 14/444,990

(22) Filed: Jul. 28, 2014

(51) Int. Cl. G06Q 30/00; G06Q 10/06; G06F 9/44

(52) U.S. Cl. CPC G06Q 30/016; G06F 9/4446; G06Q 10/06316

(57) ABSTRACT

A method for producing a record of a workflow traversal at an electronic device. A first user is guided through a first path corresponding to a first portion of an interactive guide, which includes (i) displaying a first sequence of guidance steps, wherein each respective guidance step in the first sequence of guidance steps includes a respective question and one or more respective responses to the question, and (ii) for each respective guidance step, receiving a selection of one of the respective responses to the question. For each respective guidance step in the first sequence of guidance steps, a record is stored, which includes the respective question and the selected response to the respective question. Following termination of the workflow traversal, a report is generated of the first user's path through the portion of the interactive guide.

### TECHNICAL FIELD

The present invention relates generally to data analytics, and in particular, to a method and system for producing a report related to a traversal through an interactive guide.

### BACKGROUND

Customer support is provided as a resource to customers for resolving issues encountered with various products and services. Customer support agents, who assist customers via voice or live chat by performing step-by-step troubleshooting, typically have a wide range of reference materials at their disposal to assist in the process.

Commonly used reference materials, however, are subject to a number of shortcomings. For instance, some materials are too voluminous and difficult to search efficiently. In other cases, reference materials may be too visually or technically complex, making them difficult to follow and process.

Furthermore, at the conclusion of a service interaction, agents are typically required to generate reports which summarize their interactions with the customer, a process which also suffers a number of limitations. Generating call summaries, for example, are often time-consuming and subjective in nature, and the summaries themselves, when drafted without adhering to a predefined structure or protocol, are difficult to analyze. Furthermore, summaries drafted by different agents, but describing resolutions to identical problems, are often inconsistent.

### SUMMARY

Accordingly, there is a need for devices with methods and interfaces for guiding a user through at least a portion of an interactive guide, and producing a record of the user's workflow traversal. Producing workflow traversals in such a manner provides increased consistency among the records of service interactions, enables greater insight into the effectiveness of the interactive guide and the solutions provided therein, and enables detailed analysis of specific interactions (among other possible benefits), and, consequently, increases the efficiency of customer support interactions for both customers and support agents.

In accordance with some implementations, a method for producing a record of a workflow traversal is performed at an electronic device with a processor and memory storing instructions for execution by the processor. The method includes guiding a first user through a first path corresponding to a first portion of an interactive guide, including: (1) displaying a first sequence of guidance steps, wherein each respective guidance step in the first sequence of guidance steps includes a respective question and one or more respective responses to the question, and (2) for each respective guidance step, receiving a selection of one of the respective responses to the question. The method further includes, for each respective guidance step in the first sequence of guidance steps, storing a record including the respective question and the selected response to the respective question. The method further includes, following termination of the workflow traversal, generating a report of the first user's path through the portion of the interactive guide.

In some implementations, the first sequence of guidance steps corresponds to a path through at least a portion of an interactive guide.

In some implementations, displaying the first sequence of guidance steps includes: displaying an initial guidance step; receiving a selection of one of the respective responses to the respective question in the initial guidance step; identifying a next guidance step that corresponds to the selected response; and displaying the next guidance step.

In some implementations, the report is associated with: an identifier of the first user; an entry problem; a timestamp corresponding to a beginning of the service interaction; and/or a resolution to the entry problem.

In some implementations, the report includes: for respective guidance steps of the first sequence of guidance steps, a respective duration associated with completion of the respective guidance step. Furthermore, in some implementations, the report includes audio data, wherein the audio data is synchronized with the guidance steps.

In some implementations, termination is in response to a user request to terminate the workflow traversal. In some implementations, termination is in response to navigating to a termination node.

In some implementations, the method includes providing, to the first user, access to the report of the first user's path through the portion of the interactive guide.

In some implementations, the method includes retrieving the report, and displaying the report.

In some implementations, the method includes storing the report in a report database.

In some implementations, the method includes guiding a second user through a second path corresponding to a second portion of the interactive guide, wherein the second path is distinct from the first path, including: (1) displaying a second sequence of guidance steps, wherein each respective guidance step in the second sequence of guidance steps includes a respective question and one or more respective responses to the question; and (2) for each respective guidance step in the second sequence of guidance steps, receiving a selection of one of the respective responses to the question. In some implementations, the method further includes, for each respective guidance step in the second sequence of guidance steps, storing a record including the respective question and the selected response to the respective question. In some implementations, the method further includes, following termination of the second workflow traversal, generating a report of the second user's path through the portion of the interactive guide.

In yet another aspect, an electronic device includes (a) a processor and (b) memory for storing one or more programs for execution by the processor, the one or more programs including instructions for performing any of the methods described herein.

In yet another aspect, a non-transitory computer readable storage medium stores one or more programs for execution by one or more processors, the one or more programs including instructions for performing any of the methods described herein.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram illustrating an example client-server environment of an interactive guide system, in accordance with some implementations.

FIG. 2 is a block diagram illustrating example applications in a client-server environment of an interactive guide system, in accordance with some implementations.

FIG. 3 is a block diagram illustrating an example guide server, in accordance with some implementations.

FIG. 4 is a block diagram illustrating an example client device, in accordance with some implementations.

FIG. 5 is a block diagram illustrating an example enterprise device, in accordance with some implementations.

FIG. 6A is a visual representation of a data structure of a guidance step, in accordance with some implementations.

FIG. 6B is a visual representation of an interactive guide, in accordance with some implementations.

FIG. 6C is a visual representation of an interactive guide, in accordance with some implementations.

FIG. 6D is an illustration of a user interface representation of a sequence of guidance steps, in accordance with some implementations.

FIG. 6E is an illustration of an example report generated for a traversal through an interactive guide, in accordance with some implementations.

FIGS. 7 and 8A-8D are flow diagrams illustrating methods of producing a record of a workflow traversal, in accordance with some implementations.

### DESCRIPTION OF IMPLEMENTATIONS

Reference will now be made in detail to various implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

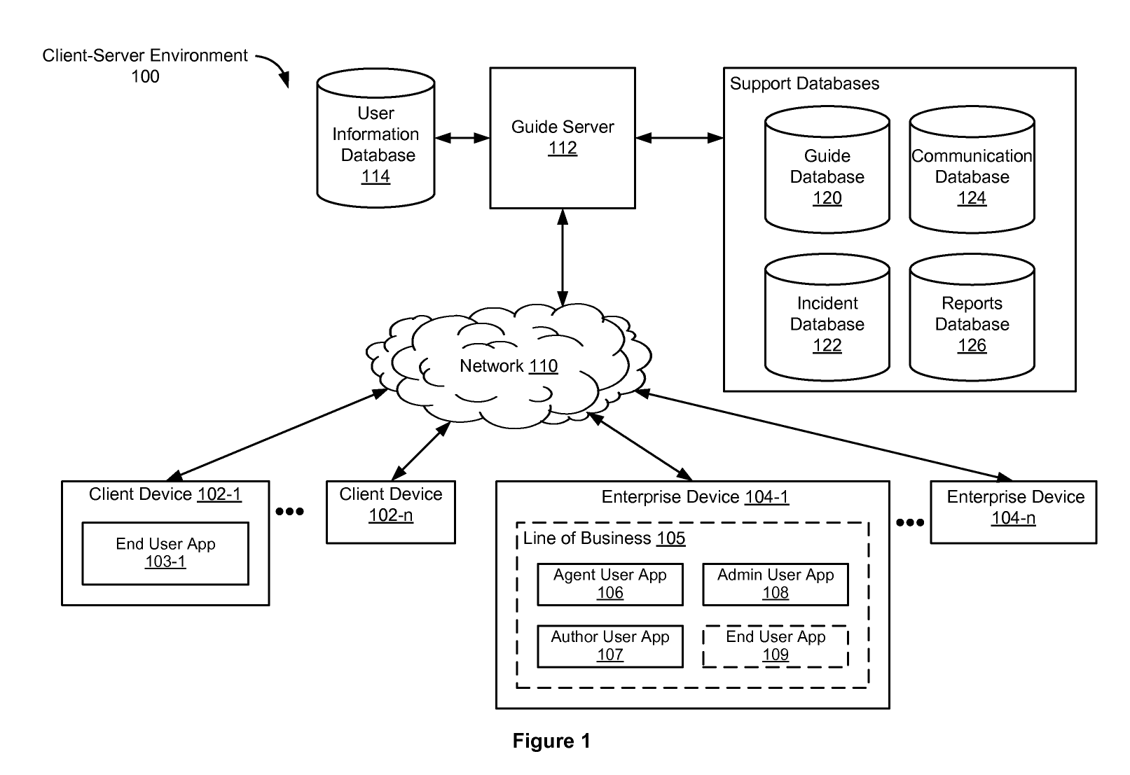

FIG. 1 is a block diagram an example client-server environment 100 of an interactive guide system, in accordance with some implementations.

The client-server environment 100 includes a number of client devices (also called “client systems,” “client computers,” or “clients”) 102-1 to 102-n and enterprise devices (also called “enterprise systems,” “enterprise computers,” or “clients”) 104-1 to 104-n, communicably connected to a guide server 112 by one or more networks 110. In some implementations, client devices 102 and enterprise devices 104 are part of a client-server relationship, where the server (e.g., guide server 112) provides one or more functions or operations for implementing the methods and features described herein. In some implementations, in providing one or more functions or operations for implementing the methods and features described herein, guide server 112 accesses and transmits information retrieved from user information database 114 and support databases (e.g., guide database 120, incident database 122, communication database 124, and/or reports database 126) to client devices 102 and enterprise devices 104. As explained below, in some other implementations, the client devices 102 and/or enterprise devices 104 are standalone systems that do not rely on or otherwise communicate with a server (e.g., guide server 112) in order to implement the methods and features described herein.

The client-server system 100 describes an environment in which interactive guides are used to provide support services to various users. For example, an interactive guide that walks a user through a sequence of interactive steps to assist the user in troubleshooting a problem with an internet connection can be stored in a database associated with guide server 112. In some cases, an end user will access the interactive guide through client device 102-1, and step through the guidance steps of the interactive guide to resolve the issue. In other cases, a support agent will access the interactive guide through enterprise device 104-1, and will use the interactive guide as a script for helping an end user troubleshoot the problem with the internet connection. (As described herein, interactive guides may instead or additionally be stored and accessed locally on client devices 102 and/or enterprise devices 104.) Accordingly, in some cases, the guide server 112 is not used. Once a user—either an end user or a support agent—has interacted with an interactive guide, the guide server 112 creates and stores a report of the traversal through the interactive guide, which is used to memorialize the support interaction. Additional examples, variations, and extensions of this process are described herein. For example, interactive guides may be used for purposes other than customer support. Indeed, in some implementations, interactive guides are used for interactive marketing (e.g., recording and generating a summary transcript of a user's selections while traversing through interactive marketing materials), medical diagnosis/treatment (e.g., recording and generating a summary transcript of a user's selections while traversing through information about symptoms, preexisting conditions, etc.), workforce training (e.g., using interactive training guides to train employees), and/or any other form of communication in which imposing a structured format is beneficial to one or more participants in the communication.

In some implementations, the client devices 102 and enterprise devices 104 are computing devices such as portable computers, tablet computers, laptop computers, desktop computers, etc., with one or more processors embedded therein or coupled thereto, or other appropriate computing devices that can be used to execute and/or display software programs.

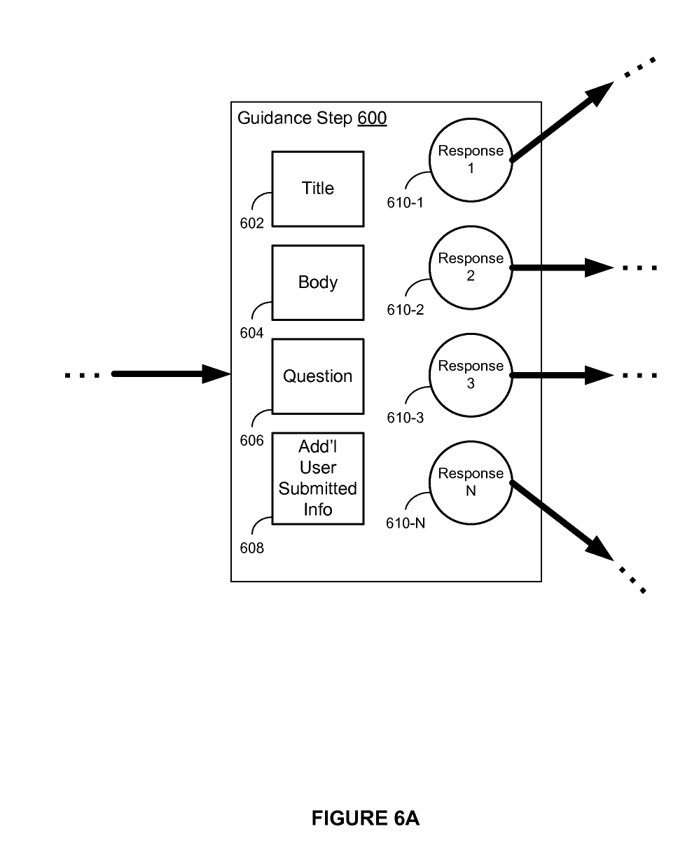

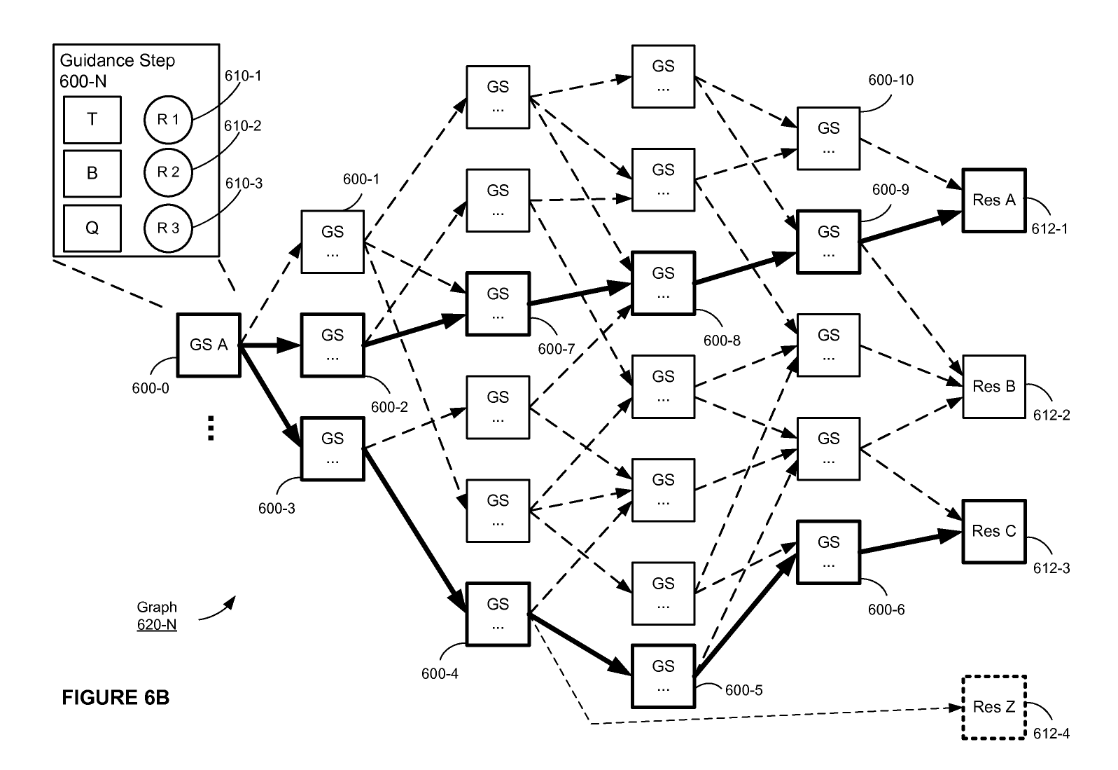

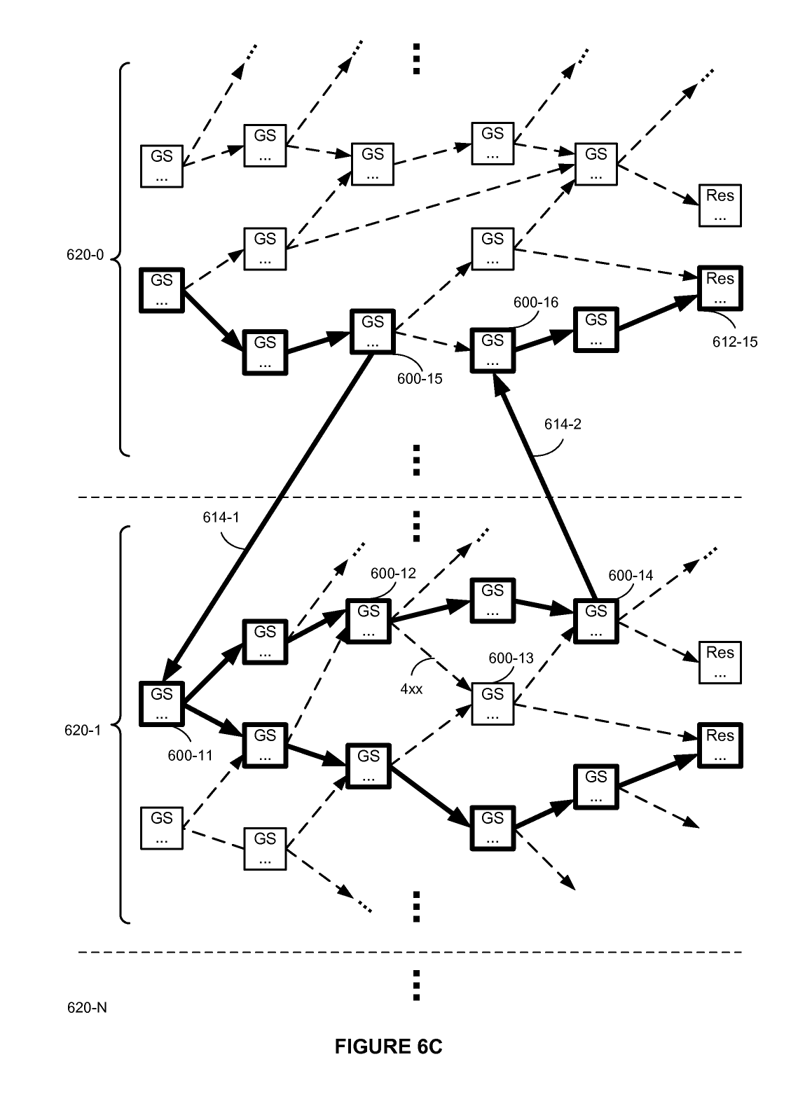

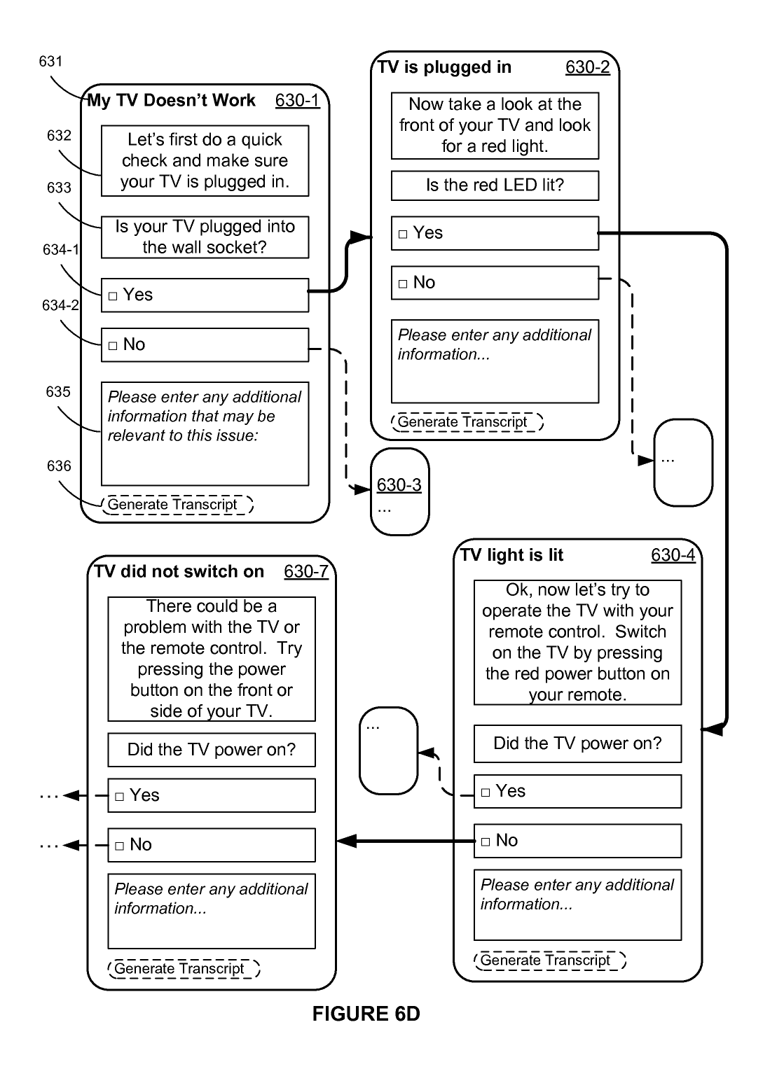

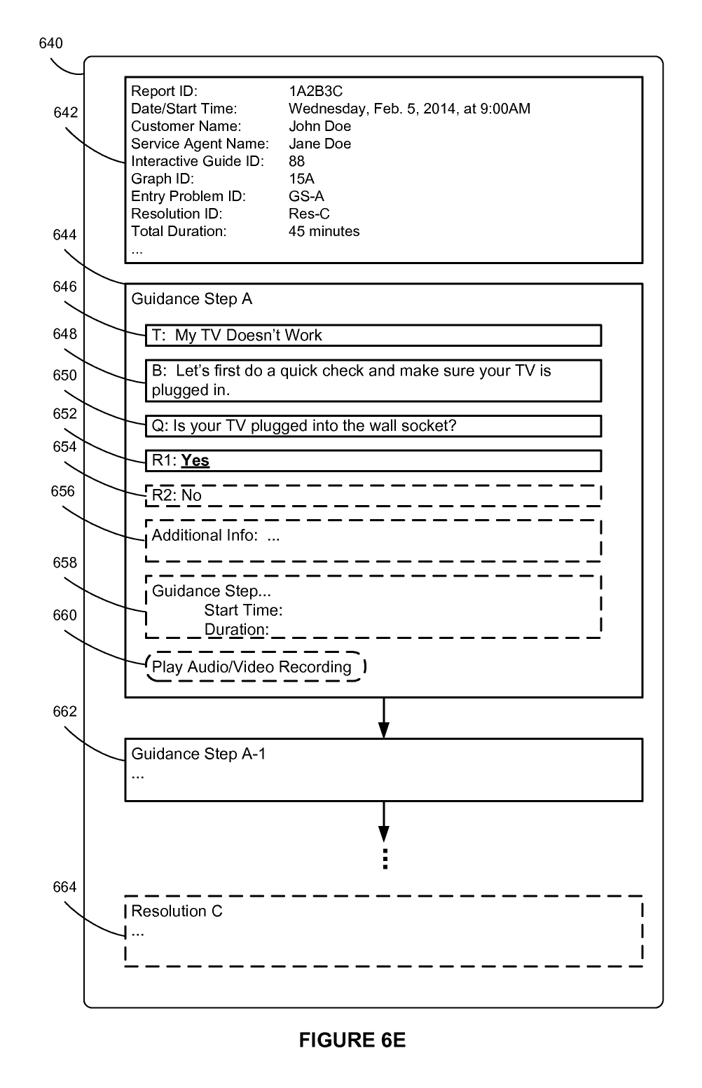

In some implementations, users employ client devices 102 to access the guide server 112. For example, one or more of the client devices 102 execute software program authoring environments that can be used to view, modify, change, or otherwise access interactive guides that are stored on guide server 112. As another example, one or more of client devices 102 execute software applications (e.g., end user application 103-1, which may be part of a developer program) that can be used to view and interact with information generated and/or transmitted by guide server 112 (e.g., using and/or viewing an interactive guide, generating a report of a user's path through a portion of an interactive guide, etc.). By way of example, a user executes the end user application 103-1 on client device 102-1, and retrieves a sequence of interactive guides (e.g., FIG. 6D) from guide server 112 for self-service, without or before contacting a customer call center.

In some implementations, a group of various enterprise users employ enterprise devices 104 to access guide server 112. For example, one or more of enterprise devices 104 execute software program authoring environments that can be used to view, modify, change, or otherwise access interactive guides that are stored on guide server 112. In some implementations, the enterprise devices 104 execute one or more software applications (e.g., agent user application 106, administrative user application 108, author user application 107, and/or end user application 109) that can be used to view and interact with information generated and/or transmitted by guide server 112 (e.g., using and/or viewing an interactive guide, generating a report of a user's path through a portion of an interactive guide, etc.).

In some implementations, one or more software applications executed in an enterprise device 104 are associated with one or more lines of business 105. A line of business 105, in some implementations, designates a particular product/service (e.g., Internet, cellular phones, television, etc.), a type of issue encountered with respect to a particular product/service (e.g., slow Internet connection, dropped calls, no dial tone, etc.), and/or a priority, difficulty, or escalation of a particular issue (e.g., Level 1, designating routine, repetitive issues with known resolutions; Level 2, designating uncommon issues that have not been resolved or require immediate attention; etc.). In some implementations, respective lines of business 105 are configured according to a respective set of configuration settings (e.g., security and access controls). Thus, in a non-limiting example, in an enterprise device 104-1, a group of software applications (e.g., 106 through 109) associated with an “Internet services” line of business 105 is only permitted to access, author, and/or modify interactive guides (stored in guide database 120) for Internet services. In some implementations, a customer site includes multiple enterprise devices 104, where each device includes software applications (e.g., 106 through 109) configured for a particular line of business 105 (e.g., enterprise device 104-1 configured for “Internet services,” enterprise device 104-2 (not shown) configured for “television services,” enterprise device 104-3 (not shown) configured for “cellular data services,” etc.).

In some implementations, the network 110 is a public communication network (e.g., the Internet or a cellular data network), a private communications network (e.g., private LAN or leased lines), or a combination of such communication networks.

In some implementations, the guide server 112 is a single computing device such as a computer server, while in other implementations, guide server 112 is implemented by multiple computing devices working together to perform the actions of a server system (e.g., cloud computing). In some implementations, guide server 112 is configured to receive and/or store data related to a user's traversal through an interactive guide (e.g., a record including a plurality of questions, and a user's responses to the questions). In some implementations, guide server 112 is configured to retrieve and/or transmit, to client devices 102 and/or enterprise devices 104, information stored in user information database 114 and/or support databases (e.g., guide database 120, incident database 122, communication database 124, and/or reports database 126). Optionally, the guide server 112 is further configured to generate additional information (e.g., reports of users' paths through interactive guides, analyses of recorded workflow traversals, etc.) based on information retrieved from user information database 114 and support databases.

In some implementations, user information database 114 and support databases (e.g., guide database 120, incident database 122, communication database 124, and/or reports database 126) are implemented by one or more computing devices, and are configured to execute one or more programs for storing, managing, and processing data stored therein. Typically, computing devices include one or more processing units (processors or cores), memory, and network/communications interfaces. In some implementations, the memory of such computing devices includes high-speed random access memory (e.g., DRAM, SRAM, DDR RAM or other random access solid state memory devices), and non-volatile memory (e.g., one or more magnetic disk storage devices, optical disk storage devices, flash memory devices, non-transitory computer readable storage mediums, or other non-volatile solid state storage devices).

In some implementations, user information database 114 is configured to store information relating to users of client devices 102 and/or enterprise devices 104. For example, in some implementations, user information database 114 stores security and access controls for client devices and/or enterprise devices. In some implementations, a user of a client device 102 or enterprise device 104 must enter log-in security credentials, which are cross-referenced against user information stored in user information database 114 to determine the permitted access controls of that user (e.g., the user may only use, but not modify or author, interactive guides), and/or to associate transaction information with the account of the user. In some implementations, an administrative user is authorized to configure security and access controls for various users (e.g., an administrative user 204 executes administrative user application 108 to define access controls to be stored in user information database 114).

In some implementations, guide database 120 is configured to store interactive guides. In some implementations, author users can create, delete, and/or modify interactive guides (e.g., through author user application 107), where the interactive guides are to be used by one or more agent users or end users (e.g., through agent user application 106 and end user application 109, respectively) and stored in guide database 120.

In some implementations, incident database 122 is configured to store traversal data, which includes data related to a user's traversal through an interactive guide. For example, traversal data includes timestamps (e.g., the times at which, and/or the durations for which, particular guidance steps of an interactive guide were displayed to a user), information relating to the sequence of guidance steps traversed (e.g., the specific guidance steps traversed, the questions and selected responses for each guidance step, etc.), and additional meta information (e.g., an identifier of a user who traversed an interactive guide; information submitted by the user, during a particular guidance step, in addition to the selection of a response; additional service interaction details, such as the total time from the beginning of service interaction to arriving at a resolution; etc.).

In some implementations, communication database 124 is configured to store information communicated by a user during, or at the conclusion of, a service interaction. Such information includes, for example, user feedback for content improvement, messages submitted from an end user to an agent user (e.g., chat messages sent by a customer to a service agent during a service interaction), messages submitted from an agent user to an end user, etc.

In some implementations, the reports database 126 is configured to store generated reports of user paths through interactive guides. For example, in some implementations, after guide server 112 retrieves information (e.g., traversal data) from incident database 122 and generates a report of a user's path through an interactive guide, the generated report is stored in reports database 126. In some implementations, each report (or a portion thereof) stored in reports database 126 is associated with a unique identifier. Furthermore, in some implementations, reports database 126 is configured to generate and/or store various analytics of stored reports. In particular, analytics generated by reports database 126 can be used to identify patterns and derive additional insights across reports (e.g., identifying frequently traversed guidance steps; identifying guidance steps that are frequently displayed for abnormally long periods of time; identifying the most common resolutions based on an entry problem; identifying lines of business, or specific issues within lines of business, that require the most time and organizational resources; etc.). Such analytics can be used by a support service provider to improve process efficiency and cost allocation for the support services that they provide.

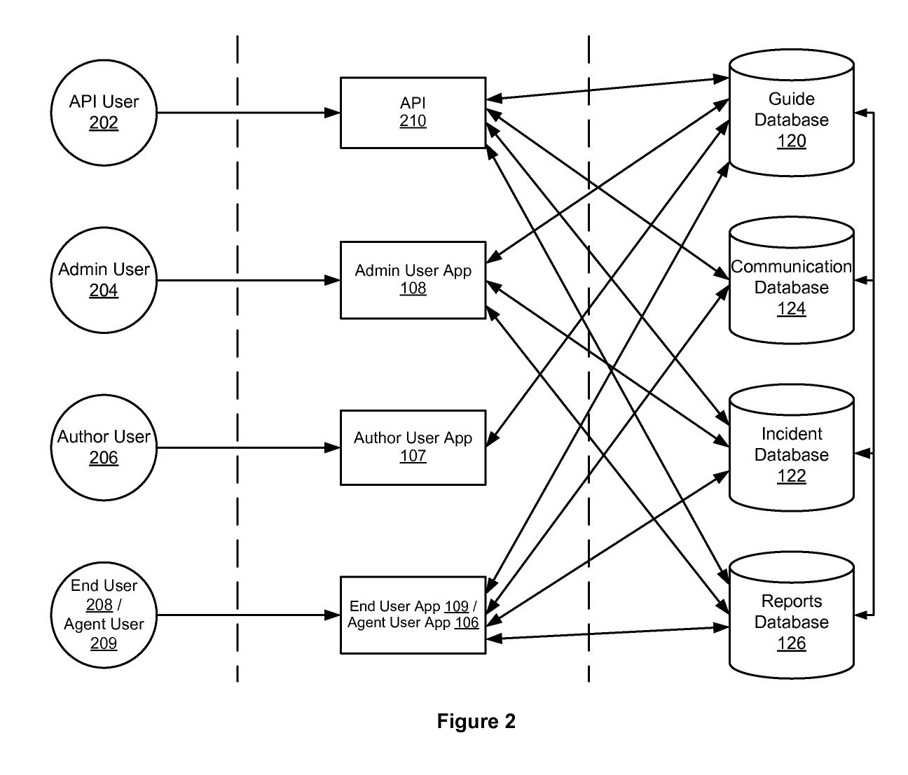

FIG. 2 is a block diagram illustrating example applications in a client-server environment, in accordance with some implementations.

Specifically, FIG. 2 illustrates an example flow of information across and between various support databases (e.g., guide database 120, incident database 122, communication database 124, and/or reports database 126) and software applications (e.g., agent user application 106, administrative user application 108, author user application 107, end user application 109, and/or any application utilizing a predefined application programming interface (API) 210), in an example client-server environment 100 (e.g., an interactive guide system). As discussed with respect to FIG. 1, in some implementations, the guide server 112 facilitates the transmission of such information to and from the client devices 102 and enterprise devices 104 which execute the software applications. A more detailed discussion regarding the various support databases is provided above with respect to FIG. 1. FIG. 2 is a non-limiting example, and any of the support databases (e.g., 120 through 126) and software applications (e.g., 106 through 109, and 210) in FIG. 2 may exchange information with one another in a given implementation.

In some implementations, an API user (e.g., 202) of a client or enterprise device (e.g., 102 or 104, respectively) executes and uses a software application that is configured to access the support databases via an application programming interface (i.e., API 210). In some implementations, the software application utilizing API 210 implements any of the methods and features of the software applications described below (e.g., agent user application 106, administrative user application 108, author user application 107, and/or end user application 109).

In some implementations, an administrative user (e.g., 204) of an enterprise device (e.g., 104) executes and uses an administrative user application 108 for guide/user management, and/or generating reports and analytics. In some implementations, through administrative user application 108, an administrative user 204 accesses interactive guides stored in guide database 120 and configures security and access controls for various users (e.g., authoring users, end users, and agent users) of a device (e.g., enterprise device 104). Various examples of security and access controls are discussed above with respect to FIG. 1. In some implementations, through administrative user application 108, an administrative user 204 requests generation of one or more reports (e.g., of a user's path through an interactive guide) and/or analytics (e.g., of one or more reports). An administrative user 204, for example, may be tasked with managing generated reports of agents belonging to a particular customer site (or line of business 105), or may be tasked with identifying patterns (e.g., by using generated analytics) across generated reports to improve operational and cost efficiency. Specifically, in some implementations, a request for a report and/or analytics is submitted by an administrative user, and in response, the requested report and/or analytics are generated by a server (e.g., guide server 112) or a support database (e.g., reports database 126). As discussed above with respect to FIG. 1, reports and analytics are generated using information retrieved from incident database 122 and/or reports database 126.

In some implementations, an authoring user (e.g., 206) of an enterprise device (e.g., 104) executes and uses an authoring user application 107 for creating, deleting, and/or modifying interactive guides stored in the guide database 120. For example, an authoring user creates a new interactive guide, one or more graphs of an interactive guide (e.g., FIG. 6C), and/or one or more guidance steps of an interactive guide (e.g., adding a new guidance step 600 to the graph of FIG. 6B). Conversely, in another example, the authoring user 206 may delete from an interactive guide any portion thereof (e.g., delete one or more graphs, and/or one or more guidance steps). In another example, an authoring user modifies the content of an existing guidance step of an interactive guide (e.g., in guidance step 630-2 of FIG. 6D, an authoring user 206 adds a third response stating “The TV does not have a red LED”).

In some implementations, an end user 208 or agent user 209 of a client or enterprise device (e.g., 102 or 104, respectively), executes and uses a respective end user application (e.g., 109) or agent user application (e.g., 106) for viewing and traversing an interactive guide (e.g., retrieved from guide database 120). In some implementations, through user application 109 or agent user application 106, a user (e.g., end user 208 or agent user 209) is presented with a sequence of guidance steps (e.g., FIG. 6D) of an interactive guide during a service interaction. In particular, based on the responses selected and the information submitted at each guidance step, the user is guided through a path of the interactive guide (e.g., path including guidance steps 600-0, 600-2, 600-7, 600-8, 600-9, and resolution 612-1, FIG. 6B). In some implementations, traversal data (e.g., timestamps, information relating to the sequence of guidance steps traversed, and/or meta information) relating to the service interaction is transmitted to and stored in incident database 122, and additional information (e.g., user feedback) communicated by the user is transmitted to and stored in communication database 124. In some implementations, a request for a report is submitted by the user, and in response, the requested report is generated by a server (e.g., guide server 112) and/or retrieved from a support database (e.g., reports database 126) for display to the user.

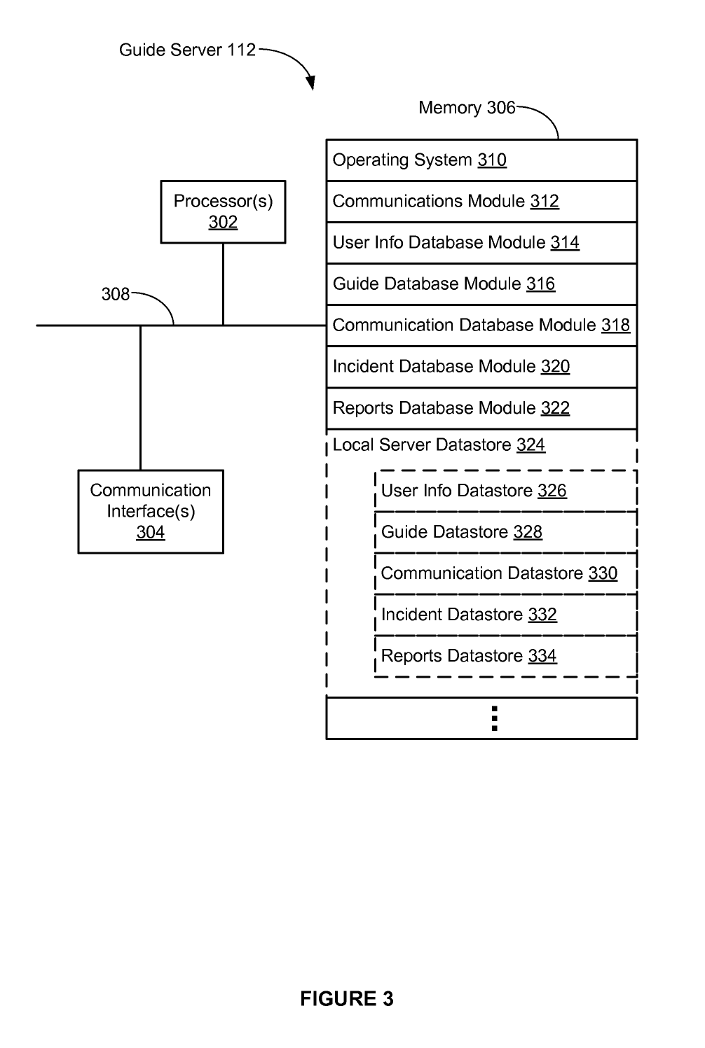

FIG. 3 is a block diagram illustrating an example guide server 112, in accordance with some implementations. The guide server 112 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The guide server 112 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the processor(s) 302. Memory 306, or alternately the non-volatile memory device(s) within memory 306, includes a non-transitory computer readable storage medium. In some implementations, memory 306 or the computer readable storage medium of memory 306 stores the following programs, modules and data structures, or a subset or superset thereof:
an operating system 310 that includes procedures for handling various basic system services and for performing hardware dependent tasks;
a network communication module 312 that is used for connecting the guide server 112 to other computers via the one or more communication network interfaces 304 (wired or wireless) and one or more communication networks, such as the Internet, cellular telephone networks, mobile data networks, other wide area networks, local area networks, metropolitan area networks, and so on;
user information database module 314 that communicates with user information database 114 to retrieve, store, and/or modify information (e.g., profiles, security and access controls, etc.) relating to users of various devices (e.g., client devices 102 and/or enterprise devices 104);
a guide database module 316 that communicates with guide database 120 to retrieve, store, modify, and/or transmit interactive guides stored in guide database 120;
a communication database module 318 that communicates with communication database 124 to retrieve, store, and/or modify information (e.g., user feedback) communicated by a user during, or at the conclusion of, a service interaction;
an incident database module 320 that communicates with incident database 122 to retrieve, store, modify, and/or transmit data related to a user's traversal through an interactive guide (e.g., traversal data, such as timestamps);
a reports module 322 that communicates with reports database 126 and/or incident database 122 to retrieve, store, modify, generate, and/or transmit reports of user paths through interactive guides, and/or additional analytics; and
optionally, a local server datastore 324, which includes one or more sub-datastores (e.g., user information datastore 326, guide datastore 328, communication datastore 330, incident datastore 332, and/or reports datastore 334), for locally and/or redundantly storing (e.g., on guide server 112) data retrieved, stored, modified, generated, and/or transmitted by corresponding database modules of guide server 112.

The databases (e.g., the user information database 114, the guide database 120, the communication database 124, the incident database 122, and the reports database 126, as well as the local server datastore 324 and its one or more sub-datastores 326 through 334) store data in one or more types of databases, such as graph, dimensional, flat, hierarchical, network, object-oriented, relational, and/or XML databases. Further, in some implementations, the data stored in user information database 114, the support databases (illustrated in FIG. 1), and/or the local server datastore 324, is accessible by one or more client devices 102 and/or enterprise devices 104. Data in any of the above-mentioned databases or datastores is stored as any appropriate data structure, such as a text file (e.g., ASCII, SGML, HTML), a table, or the like.

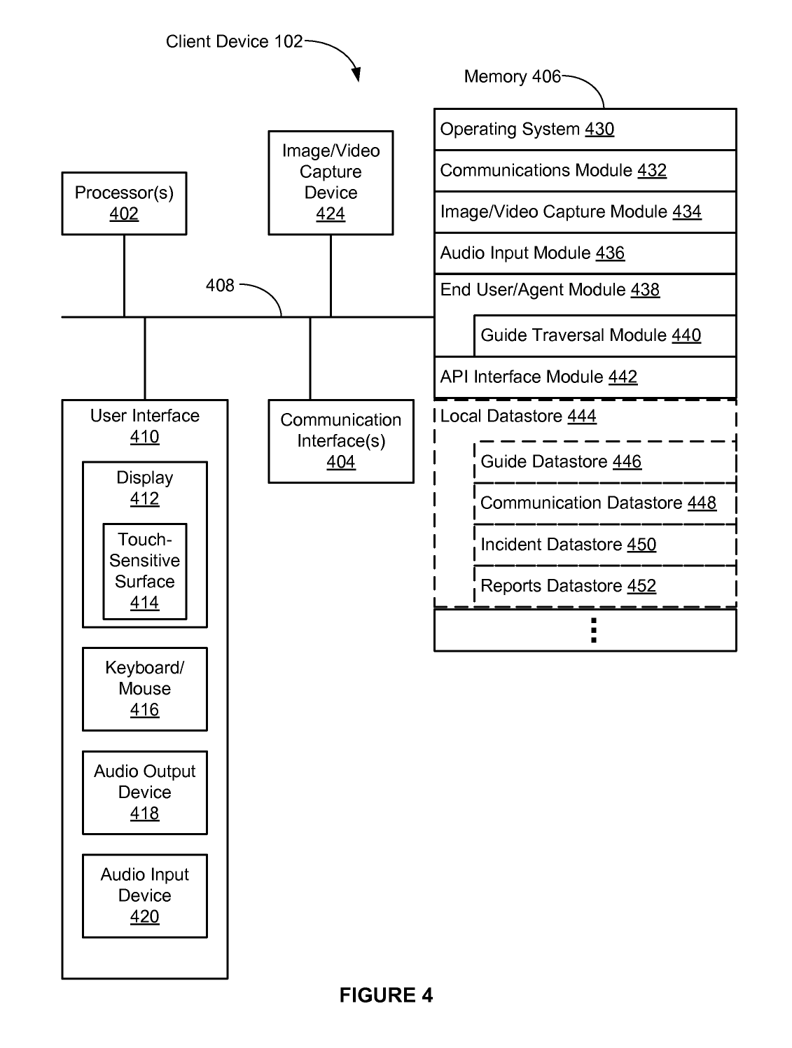

FIG. 4 is a block diagram illustrating an example client device 102, in accordance with some implementations. The client device 102 typically includes one or more processing units (processors or cores) 402, one or more network or other communications interfaces 404, memory 406, and one or more communication buses 408 for interconnecting these components. The communication buses 408 optionally include circuitry (sometimes called a chipset) that interconnects and controls communications between system components. The client device 102 includes a user interface 410. The user interface 410 typically includes a display device 412. In some implementations, the client device includes inputs such as a keyboard, mouse, and/or other input buttons 416. Alternatively or in addition, in some implementations, the display device 412 includes a touch-sensitive surface 414, in which case the display device 412 is a touch-sensitive display. In client systems that have a touch-sensitive display 412, a physical keyboard is optional (e.g., a soft keyboard may be displayed when keyboard entry is needed). The user interface 410 also includes an audio output device 418, such as speakers or an audio output connection connected to speakers, earphones, or headphones. Furthermore, some client devices 102 use a microphone and voice recognition to supplement or replace the keyboard. Optionally, the client device 102 includes an audio input device 420 (e.g., a microphone) to capture audio (e.g., speech from a user). The client device 102 also optionally includes an image/video capture device 424, such as a camera or webcam.

Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the processor(s) 402. Memory 406, or alternately the non-volatile memory device(s) within memory 406, includes a non-transitory computer readable storage medium. In some implementations, memory 406 or the computer readable storage medium of memory 406 stores the following programs, modules and data structures, or a subset or superset thereof:
an operating system 430 that includes procedures for handling various basic system services and for performing hardware dependent tasks;
a network communication module 432 that is used for connecting the client device 102 to other computers via the one or more communication network interfaces 404 (wired or wireless) and one or more communication networks, such as the Internet, cellular telephone networks, mobile data networks, other wide area networks, local area networks, metropolitan area networks, and so on;
an optional image/video capture module 434 (e.g., a camera module) for processing a respective image or video captured by the optional image/video capture device 424;
an optional audio input module 436 (e.g., a microphone module) for processing audio captured by the optional audio input device 420;
an end user/agent module 438 that communicates with guide server 112 to receive and/or display guidance steps of one or more interactive guides (e.g., 630-1, FIG. 6D) stored in guide database 120, which includes:
   a guide traversal module 440 that records and/or stores, and optionally transmits to guide server 112, information corresponding to a user's traversal through at least a portion of the interactive guide (e.g., user selected responses, a sequence of guidance steps, a resolution, an entry problem, additional user submitted information, audio recordings, etc.);
an API interface module 442, utilized by one or more applications (corresponding to a set of executable instructions stored in memory 406) to perform one or more functions described with respect to any of the above modules; and
optionally, a local datastore 444, which includes one or more sub-datastores (e.g., guide datastore 446, communication datastore 448, incident datastore 450, and/or reports datastore 452), for locally storing (e.g., on client device 102) data retrieved, stored, modified, generated, and/or transmitted by another device (e.g., the guide server 112 and/or the corresponding databases in communication with the guide server 112).

The local datastore 444 (and its one or more sub-datastores 446 through 452) stores data in one or more types of databases, such as graph, dimensional, flat, hierarchical, network, object-oriented, relational, and/or XML databases. Data in any of the above-mentioned databases or datastores is stored as any appropriate data structure, such as a text file (e.g., ASCII, SGML, HTML), a table, or the like.

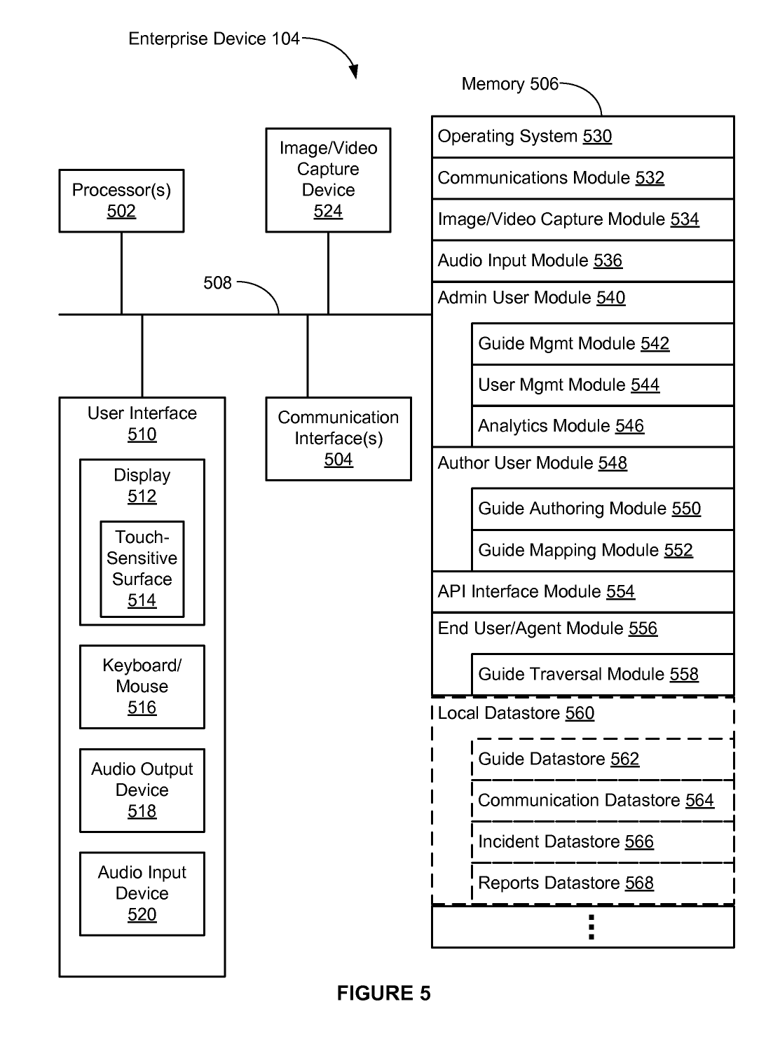

FIG. 5 is a block diagram illustrating an example enterprise device 104, in accordance with some implementations. The enterprise device 104 typically includes one or more processing units (processors or cores) 502, one or more network or other communications interfaces 504, memory 506, and one or more communication buses 508 for interconnecting these components. The communication buses 508 optionally include circuitry (sometimes called a chipset) that interconnects and controls communications between system components. The enterprise device 104 includes a user interface 510. The user interface 510 typically includes a display device 512. In some implementations, the enterprise device 104 includes inputs such as a keyboard, mouse, and/or other input buttons 516. Alternatively or in addition, in some implementations, the display device 512 includes a touch-sensitive surface 514, in which case the display device 512 is a touch-sensitive display. In enterprise devices that have a touch-sensitive display 512, a physical keyboard is optional (e.g., a soft keyboard may be displayed when keyboard entry is needed). The user interface 510 also includes an audio output device 518, such as speakers or an audio output connection connected to speakers, earphones, or headphones. Furthermore, enterprise devices 104 use a microphone and voice recognition to supplement or replace the keyboard. Optionally, the enterprise device 104 includes an audio input device 520 (e.g., a microphone) to capture audio (e.g., speech from a user). The enterprise device 104 also optionally includes an image/video capture device 524, such as a camera or webcam.

Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the processor(s) 502. Memory 506, or alternately the non-volatile memory device(s) within memory 506, includes a non-transitory computer readable storage medium. In some implementations, memory 506 or the computer readable storage medium of memory 506 stores the following programs, modules and data structures, or a subset or superset thereof:
an operating system 530 that includes procedures for handling various basic system services and for performing hardware dependent tasks;
a network communication module 532 that is used for connecting the enterprise device 104 to other computers via the one or more communication network interfaces 504 (wired or wireless) and one or more communication networks, such as the Internet, cellular telephone networks, mobile data networks, other wide area networks, local area networks, metropolitan area networks, and so on;
an optional image/video capture module 534 (e.g., a camera module) for processing a respective image or video captured by the optional image/video capture device 524;
an optional audio input module 536 (e.g., a microphone module) for processing audio captured by the optional audio input device 520 (e.g., audio recordings captured during a service interaction);
an administrative user module 540 that communicates with guide server 112 to manage an interactive guide, which includes:
   a guide management module 542 that allows a user, through the enterprise device 104, to access, manage, and/or configure one or more aspects of an interactive guide (e.g., access controls, user interface, etc.);
   a user management module 544 that configures access controls for users of a respective enterprise device 104 (e.g., profiles, security and access controls, etc.); and
   an analytics module 546 that accesses, manages, and/or generates reports and/or analytics (e.g., retrieves reports and developing analytics based on those reports);
an author user module 548 that communicates with guide server 112 to allow a user to create, delete, and/or modify interactive guides stored in guide database 120, which includes:
   a guide authoring module 550 that allows a user to create and/or modify guidance steps of an interactive guide; and
   a guide mapping module 552 that allows a user to create and/or modify associations between guidance steps of an interactive guide, and/or create and/or modify graphs within an interactive guide (e.g., organized sub-portions of an interactive guide, consisting of a plurality of linked guidance steps);
an API interface module 554, utilized by one or more applications (corresponding to a set of executable instructions stored in memory 406) to perform one or more functions described with respect to any of the above modules;
an end user/agent module 556 that communicates with guide server 112 to receive and/or display guidance steps of one or more interactive guides (e.g., 630-1, FIG. 6D) stored in guide database 120, which includes:
   a guide traversal module 558 that records and/or stores, and optionally transmits to guide server 112, information corresponding to a user's traversal through at least a portion of the interactive guide (e.g., user selected responses, a sequence of guidance steps, a resolution, an entry problem, additional user submitted information, audio recordings, etc.);
optionally, a local datastore 560, which includes one or more sub-datastores (e.g., guide datastore 562, communication datastore 564, incident datastore 566, and/or reports datastore 568), for locally storing (e.g., on enterprise device 104) data retrieved, stored, modified, generated, and/or transmitted by another device (e.g., the guide server 112 and/or the corresponding databases in communication with the guide server 112).

The local datastore 560 (and its one or more sub-datastores 562 through 568) stores data in one or more types of databases, such as graph, dimensional, flat, hierarchical, network, object-oriented, relational, and/or XML databases. Data in any of the above-mentioned databases or datastores is stored as any appropriate data structure, such as a text file (e.g., ASCII, SGML, HTML), a table, or the like.

Each of the above identified modules and applications in FIGS. 3-5 correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various implementations. In some implementations, memory 306, 406, and/or 506 store a subset of the modules and data structures identified above. Furthermore, memory 306, 406, and/or 506 optionally store additional modules and data structures not described above.

FIGS. 6A-6E illustrate various aspects of an interactive guide system, including visual representations of the data structure of a guidance step and the backend architecture of an interactive guide system, as well as user interface representations of a sequence of guidance steps and an example of a report generated for a user's traversal through an interactive guide. While some example features are illustrated, various other features have not been illustrated for the sake of brevity and to avoid obscuring more pertinent aspects of the example implementations disclosed herein.

FIG. 6A is a visual representation of the data structure of a guidance step, in accordance with some implementations. As a non-limiting example, the data structure of a guidance step 600 includes multiple elements, including a title 602, body 604, question 606, additional user submitted information 608, and responses 610 (e.g., 610-1 through 610-N). The guidance step 600 is described with reference to an example step of an interactive guide for troubleshooting a television that does not work. This is merely one example, however, and one of ordinary skill in the art will recognize that the questions, responses, titles, etc., described with reference to the guidance step 600 can be tailored to many different interactive guides spanning many different support issues (e.g., billing questions, technical troubleshooting, financial service issues, etc.). In some implementations, data structures of guidance steps in an interactive guide are stored in guide database 120 (or optionally, in the memory 306 of the guide server 112 of FIG. 3), and retrieved by guide database module 316 upon request by the client device 102 and/or the enterprise device 104.

The title 602 for a respective guidance step 600 describes a particular issue to which the respective guidance step relates (e.g., “My TV doesn't work,” where the respective guidance step includes questions for the resolution of the particular issue), or information related to a previous guidance step (e.g., “TV is plugged in,” the title of a guidance step presented subsequent to a guidance step for walking a user through checking whether the TV was plugged in). Alternatively, title 602 is an arbitrary label associated with a respective guidance step.

In some implementations, the body 604 includes instructions for the user (e.g., “Try pressing the power button on the front or side of your TV”), or supplemental text related to the guidance step (e.g., “There could be a problem with the TV or the remote control.”).

In some implementations, the question 606 is a question presented to the user after the user has presumably carried out the set of instructions provided in the body 604, or that generally prompts the user to select one of the responses 610 (e.g., “Did the TV power on?”).

In some implementations, responses 610 represent one or more selectable responses relevant to a question 606 that is presented in a respective guidance step 600. In some implementations, responses 610 represent a binary set of responses (e.g., response 610-1 states “Yes,” response 610-2 states “No”), while in other implementations, responses 610 are arbitrarily defined statements or descriptions (e.g., response 610-1 states “The TV screen is displaying static,” response 610-2 states “The TV screen is blank,” response 610-3 states “The TV screen is flashing,” etc.). In some implementations, one or more responses 610 of a respective guidance step 600 correspond to (i.e., are logically linked to) a next guidance step in the interactive guide, as discussed and shown with respect to FIG. 6B.

In some implementations, the additional user submitted information 608 is a data entry field in which users can include information that may be relevant to the service interaction. In other words, the additional user submitted information 608 can be used to help re-direct the user to a different interactive guide, to a particular graph within an interactive guide (e.g., re-directing from graph 620-0 to 620-1, shown by re-direction path 614-1, FIG. 6C), to a different guidance step (e.g., re-directing from guidance step 600-14 to 600-16, shown by re-direction path 614-2 in graph 620-1, FIG. 6C), and/or to a final resolution (e.g., re-directing from guidance step 600-4 to resolution 612-4, FIG. 6B). In some implementations, if the selectable responses for a guidance step do not represent how a user would accurately respond to a question presented, additional user submitted information 608 allows the user to provide additional relevant information. For example, if a guidance step presents the question, “Is the red LED lit?,” but the user's television does not have a red LED light, the user may submit information indicating that the user is unable to accurately or properly respond to the question, potentially suggesting that an incorrect interactive guide is being used (e.g., an interactive guide corresponding to a different television manufacturer). In some implementations, additional user submitted information 608 is processed in generating analytics, which an author user may use in creating new guidance steps, or modifying existing guidance steps, for an interactive guide.

In some implementations, a user (e.g., authoring user 206 and/or administrative user 204, FIG. 2) creates text-based content corresponding to data elements (e.g., title 602, body 604, question 606, responses 610, etc.), specific examples of which are discussed with reference to FIG. 6D.

FIG. 6B is a visual representation of an interactive guide system, in accordance with some implementations. A non-limiting example is provided, which illustrates an example graph 620-N of an interactive guide. As described herein, a graph is a sub-portion of an interactive guide, which may be related to a particular subject matter within a larger context. For example, an interactive guide for troubleshooting internet connection issues may have a graph related to computers, another graph related to routers, and another graph related to modems. As described herein, graphs may be interlinked with each other. Accordingly, when a user who is troubleshooting a failed internet connection is traversing the “computer” graph, a particular response to a particular guidance step may indicate that the problem is actually with the modem. Accordingly, the user will be redirected to the “modem” graph. In some implementations, the redirection between graphs is transparent to the user-guidance steps of the new graph are presented to the user without disrupting the process, requiring the user to start over, or the like. In some implementations, the components of an interactive guide correspond to guidance steps and other information of an interactive guide, which is stored in guide database 120 (or optionally, in the memory 306 of the guide server 112 in FIG. 3), and retrieved by guide database module 316 upon request by the client device 102 and/or the enterprise device 104.

FIG. 6B illustrates multiple guidance steps (e.g., 600-1, 600-2, etc.), resolutions (e.g., 612-1, 612-2, etc.), and resolution pathways. Resolution pathways are sequences of guidance steps that terminate at a resolution node (e.g., an example resolution pathway begins with the entry problem, represented by guidance step 600-0, and further includes guidance steps 600-2, 600-7, 600-8, 600-9, and resolution node 612-1). As described with respect to FIG. 6D, a user is presented with a guidance step (e.g., 600-0) including a question and one or more selectable responses. Based on a selected response, the user will be presented with a subsequent guidance step corresponding to the response selected (e.g., guidance step 600-1 is presented if the user selects a corresponding response), and the process is repeated at each subsequent guidance step until termination is reached. A termination is reached, for example, when the user manually terminates the service interaction (e.g., by closing an application providing the guidance steps, or otherwise terminating or exiting the interactive guide), or when the user reaches a resolution node (e.g., resolution node 612-1).

In some implementations, a graph 620-N corresponds to one or more entry problems (e.g., TV is not working, premium channels are unavailable, etc.). Additionally and/or alternatively, a graph 620-N corresponds to one or more lines of business (e.g., lines of business 105, FIG. 1, such as “cellular services” or “home telephone services”). In some implementations, an interactive guide includes one or more graphs 620-N. Furthermore, in some implementations, an interactive guide is structured as a multi-relationship directed graph. One type of a multi-relationship directed graph is a directed acyclic graph.

In some implementations, each selectable response of a respective guidance step 600 is linked to (i.e., directs a user to) a subsequent guidance step (e.g., responses 610-1, 610-2, and 610-3 of guidance step 600-0, correspond to guidance steps 600-1, 600-2, and 600-3, respectively), or alternatively, a resolution 612 node (e.g., responses 610-1 and 610-2 of guidance step 600-9, correspond to resolution nodes 612-1 and 612-2, respectively). In some implementations, a subsequent guidance step may correspond to a selectable response of two or more respective guidance steps (e.g., a response of guidance step 600-1 and a response of guidance step 600-2 both correspond to subsequent guidance step 600-7). In an example, if guidance step 600-1 indicates that a user is unable to adjust the volume of the television using a remote, and if guidance step 600-2 indicates that a user is unable to change a channel using a remote, guidance step 600-7 may include instructions for the user to check the batteries of the remote.

In some implementations, a resolution node 612-N identifies a solution to an entry problem. For example, if a user initiates a service interaction because the user's cell phone is not working (e.g., the entry problem represented by guidance step 600-0), the user traverses a sequence of guidance steps 600 and may ultimately reach a resolution node 612-1 that identifies a defective power button as the cause of the entry problem. In some implementations, a resolution node 612 will correspond to a selectable response of two or more respective guidance steps (e.g., a response of guidance step 600-9 and a response of guidance step 600-10 both correspond to resolution 612-1) and/or entry problems. In one example, a user who is unable to adjust a volume using a remote, follows instructions in guidance step 600-9 and successfully adjusts the volume using controls located on the television. In the same example, a different user who is unable to change channels using a remote, follows instructions in guidance step 600-10 and successfully changes channels using controls located on the television. Thus, resolution 612-1, which corresponds to a respective response in each of guidance steps 600-9 and 600-10, ultimately identifies that the remote's batteries are depleted or malfunctioning.

Furthermore, in some implementations, an entry problem (e.g., guidance step 600-0) has multiple resolution pathways. In the example provided, one resolution pathway for an entry problem 600-0 (e.g., TV not working) includes guidance steps 600-2, 600-7, 600-8, and 600-9, and resolution 612-1 (e.g, TV screen defective), while a different resolution pathway for the same entry problem includes guidance steps 600-0, 600-3, 600-4, 600-5, and 600-6, and resolution 612-3 (e.g., TV power supply defective).

FIG. 6C is a visual representation of an interactive guide, in accordance with some implementations. In FIG. 6C, multiple graphs (e.g., 620-0 and 620-1) of an interactive guide are illustrated, each having multiple guidance steps (e.g., 600-11, 600-12, etc.) and multiple resolutions (e.g., 612-15). As illustrated, in some implementations, a user is re-directed from one graph to a different graph (e.g., from graph 620-0 to graph 620-1) based on the particular responses selected by a user, and the particular links between graphs.

More specifically, in some implementations, a user will be re-directed to a different graph based on a selection of a particular response in a particular guidance step (e.g., 600-15). In some implementations, a selected response indicates that a different graph will be more suitable to the user's issue. For example, a user's inability to browse the Internet on a cell phone, while initially classified as an entry problem in a graph corresponding to “cellular hardware,” is better resolved through a different graph corresponding to “cellular data plans.” This condition is determined, for example, when a guidance step or series of guidance steps in a first graph (e.g., graph 620-0) result in a determination that the user does not have sufficient funds in a cellular data account (e.g., at step 600-15).

In some implementations, a user is re-directed to a guidance step of another graph (e.g., from guidance step 600-14 of graph 620-1 to guidance step 600-16 of graph 620-0, along re-direction path 614-2). In other implementations, a user is re-directed to an alternative entry problem of another graph (e.g., from guidance step 600-15 of graph 620-0, to entry problem 600-11 of graph 620-1, along re-direction path 614-1). Furthermore, in some implementations, a graph 620-N represents a different level of priority or escalation. Thus, for example, a user is re-directed (or “escalated”) from one graph (e.g., 620-0) to a different higher-priority graph (e.g., 620-1), within the same or a different interactive guide, if a user selected response and/or additional user submitted information indicates that special attention is required (e.g., from a different line of business 105, a special service agent user 209, etc.).

FIG. 6D is an illustration of a user interface representation of a sequence of guidance steps, in accordance with some implementations. More specifically, FIG. 6D illustrates a portion of an example sequence of guidance steps (e.g., 630-1, 630-2, 630-4, 630-7), representing one possible path (e.g., a resolution pathway) of a user, where the path corresponds to a portion of an interactive guide.

FIG. 6D illustrates example data elements for each displayed guidance step. For example, the user interface representation of guidance step 630-1 includes title 631 (“My TV Doesn't Work”), body 632 (“Let's first do a quick check and make sure your TV is plugged in.”), question 633 (“Is your TV plugged into the wall socket?”), responses 634 (“Yes” and “No”), a user submitted information field 635, and an optional “generate transcript” affordance 636.

As the example illustrates, upon initiating a service interaction (e.g., an end user initiating a self-service interaction with an interactive guide, or a support agent initiating an interaction with an interactive guide as a reference to assist an end user), a user begins with guidance step 630-1, which corresponds to an entry problem (e.g., the user's television does not work). In some implementations, the entry problem determines an appropriate interactive guide, and/or a particular graph of an interactive guide (e.g., graph 620-0, FIG. 6C), that the user will traverse for an initiated service interaction.

A guidance step presents a user with a set of instructions and/or a summary of the purpose of the guidance step (e.g., body 632, stating that the step is to ensure that the user's TV is plugged in) and a follow-up question or instruction (e.g., question 633, asking the user “Is your TV plugged into the wall socket?”). The user responds to the follow-up question or instruction by selecting a response (e.g., response 634-1, 634-2). Depending on the response that the user selects (e.g., response 634-1 “Yes,” or response 634-2 “No”), a next guidance step that corresponds to the selected response is identified and displayed. For example, if the user selects response 634-1 “Yes,” the next guidance step is step 630-2. On the other hand, if the user selects response 634-2 “No,” the next guidance step is step 630-3. FIG. 6D illustrates that the user has selected response 634-1 “Yes,” resulting in the presentation of step 630-2.

In some implementations, after a response is selected, a record of the service interaction is stored (e.g., in incident database 122, by guide server 112, FIG. 1). The record includes the question (e.g., question 633), the selected response (e.g., response 634-1), and/or other information related to the guidance step (e.g., time at which guidance step 630-1 was presented, duration of interacting with the guidance step, etc.). In some implementations, a data structure that defines the entire step is stored.

In some implementations, the user progresses through a sequence of guidance steps (e.g., 630-1, 630-2, 630-4, 630-7, etc.) until a resolution is identified, or optionally, the user manually terminates the service interaction (e.g., by selecting an optional termination affordance, not shown in FIG. 6B, by exiting an application through which the user is interacting with the interactive guide, etc.).

In some implementations, the generate transcript affordance 636, when selected by a user, generates a report of a user's path through a portion of an interactive guide, as described with respect to FIGS. 1-3 and 6E. The report is then stored (e.g., in reports database 126 and/or reports datastores 334, 452, and/or 568). In some implementations, the report is also sent to (e.g., via email, direct file transfer, etc.) to the user, or to another party, such as the business entity responsible for the interactive guide, a supervisor of the user (in cases where the user is a service agent), and the like.

FIG. 6E is an illustration of an example report generated for a traversal through an interactive guide, in accordance with some implementations. The non-limiting example illustrates a generated report (e.g., 640) including a report information section (e.g., 642), a sequence of guidance steps (e.g., guidance steps 644, 662, etc.), and optionally, a resolution (e.g., 664), which collectively represents a user's traversal through a portion of an interactive guide.

In some implementations, report 640 is a text file. In some implementations, report 640 is a multimedia file, including any combination of text, graphics, audio, and/or video. In some implementations, report 640 is automatically generated at the termination of a user's traversal through a portion of an interactive guide (e.g., navigating to resolution 612-15, FIG. 6C). Optionally, report 640 is generated when a user (e.g., end user 208, or agent user 209) manually terminates the traversal of the interactive guide (e.g., by selecting generate transcript affordance 636, FIG. 6D, exiting an application through which the user is interacting with the interactive guide, etc.).

In some implementations, report information section 642 includes one or more fields containing information related to a user's traversal through an interactive guide. In some implementations, report information section 642 includes the following fields, or a subset or superset thereof:
“Report ID,” which identifies a unique identifier associated with the report;
“Date/Start Time,” which identifies the date and time when the service interaction corresponding to the report took place;
“Customer Name,” which identifies the name of the individual for whom the service was provided (e.g., end user 208, FIG. 2);
“Service Agent Name,” which identifies the service agent's name (if any) who used the interactive guide in furtherance of a service interaction with an end user (e.g., agent user 209, FIG. 2);
“Interactive Guide ID,” which is a unique identifier of an interactive guide through which the user traversed;
“Graph ID,” which is a unique identifier of a graph through which the user traversed (if the traversal is associated with a particular graph);
“Entry Problem ID,” which is a unique identifier of an entry problem of the service interaction, and/or a textual description of the entry problem (e.g., “TV won't turn on,” not shown);
“Resolution ID,” which is a unique identifier of the resolution to the entry problem, and/or a textual description of the resolution (e.g., “TV was not plugged in,” not shown); and
“Total Duration,” which identifies the total duration of a service interaction.

In some implementations, report 640 includes a sequence of guidance steps (e.g., 644, 662, etc.), and optionally, a resolution (e.g., 664), presented to a user during the user's traversal through a portion of an interactive guide. In some implementations, the display of a guidance step (e.g., 644) in report 640 includes information from the respective guidance step, such as a title 644, a body 648, a question 650, and one or more responses (e.g., 652 and 654). In some implementations, the display of a guidance step includes only a selected response (e.g., 652). In other implementations, the display of a guidance step includes both the selected response and one or more responses that were not selected (e.g., “654”). In some implementations, all responses that were in the guidance step are included in the report.

Furthermore, in some implementations, the display of the guidance step 644 in the report includes additional user submitted information 656, guidance step statistics 658, and/or a play audio/video recording affordance 660. In some implementations, guidance step statistics 658 include time-based information regarding a respective guidance step (e.g., a start time, indicating the time at which the user was first presented with the respective guidance step during a service interaction, and/or a duration, indicating a total time the respective guidance step was displayed before the user selected a response).

In some implementations, the play audio/video recording affordance 660, when selected, triggers playback of at least a portion of an audio/video recording corresponding to the service interaction. For example, in some implementations, individual audio/video files are recorded and stored for each guidance step of a traversal of an interactive guide. Thus, selection of the play audio/video recording affordance 660 will cause playback of the audio/video file for that guidance step. As another example, in some implementations, an audio and/or video file is recorded for the entire duration of a user's interaction with an interactive guide, and the file is stored as a single audio/video file. In this case, the play audio/video recording affordance 660, when selected, causes playback of the audio/video file starting at the start time of, and lasting for the duration of, the guidance step. In some embodiments, the audio/video file is indexed (i.e., tags that define segments that correspond to particular guidance steps are inserted into and/or associated with the file), and the play audio/video recording affordance 660 is associated with a particular tag or addressed location within the audio/video file such that, when selected, the audio/video file is played back from the identified tag.

In some implementations, report 640 further includes analytics, wherein the analytics are generated by a server (e.g., guide server 112, FIG. 1) or a support database (e.g., reports database 126) using information retrieved from support databases (e.g., incident database 122 and/or reports database 126).

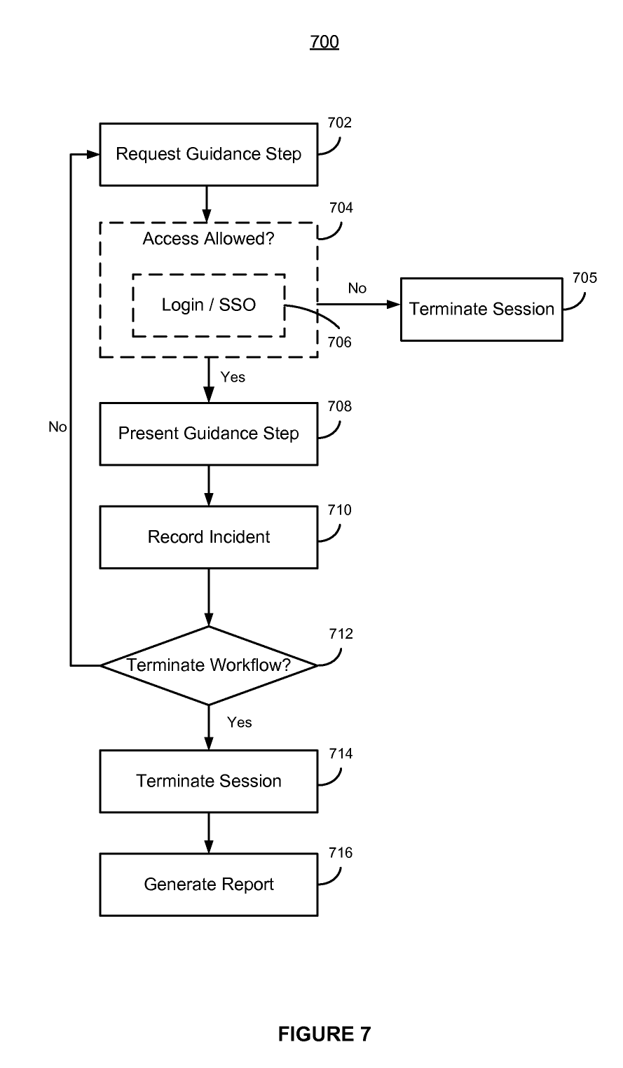

FIG. 7 is a flow diagram illustrating a method 700 of producing a record of a workflow traversal, in accordance with some implementations. The method 700 is performed, in some implementations, on a standalone device (e.g., client device 102-1 or enterprise device 104-1, where client device 102-1 or enterprise device 104-1 is acting as a standalone device). In some implementations, the method 700 is performed by a server device (e.g., guide server 112) that sends information to a client (e.g., client device 102-1 or enterprise device 104-1) for display. In some implementations, the method 700 is performed in part by a client (e.g., 102-1, 104-1) and in part by a server (e.g., guide server 112). For ease of reference, the method 700 will be described below as being performed simply by a device. It will be understood that, in various implementations, steps of the method 700 are performed by any of the aforementioned devices or combination of devices. FIG. 7 corresponds to instructions stored in a computer memory or computer readable storage medium (e.g., memory 306 of the guide server 112, memory 406 of the client device 102-1, and/or memory 506 of the enterprise device 104-1).

A device requests a guidance step and initiates a session (702) (e.g., with end user/agent module 438 and/or 556). For example, a user (e.g., end user 208 or agent user 209) initiates a service interaction and identifies a problem (e.g., entry problem, topic, etc.), thus initiating an interactive guide, one or more graphs within the interactive guide, and/or an initial guidance step. For example, if the problem is that a cell phone cannot make calls, a “Telephone” interactive guide may be selected, and, specifically, a graph within the “Telephone” interactive guide directed to “Cellular Phones.”

In some implementations, the device then determines (704) if the requesting user has access to the requested content. In some implementations, a server (e.g., guide server 112) retrieves user information from the device (e.g., with user information database module 314), and cross-references the user information against information from a database (e.g., user information database 114) to determine whether the user has the appropriate access privileges (security and access controls discussed with respect to FIG. 1). Optionally, an authentication mode is selected (706).

In accordance with a determination that the user does not have the required access controls for the requested content, the session is terminated (705). In accordance with a determination that the user does have the required access controls for the requested content, however, the requested guidance step is presented, wherein the guidance step includes a question and one or more selectable responses to the question (708) (e.g., presented by guide server 112 by using guide database module 316). Further implementations of interactive guides and guidance steps are discussed in with respect to FIGS. 6A-6D.

The device records incidents throughout the service interaction (710) (e.g., with reports module 322). Incidents include, for example, user selected responses, additional user submitted information, and/or audio recordings.

The device determines whether a request to terminate the workflow or a request for a subsequent guidance step is detected (712) (e.g., with guide traversal module 440 and/or 558). In some implementations, a workflow terminates if a user manually requests termination (e.g., selecting a workflow termination affordance, exiting an application through which the user is interacting with the interactive guide, etc.). Alternatively, a workflow terminates if the user navigates to a termination node (e.g., resolution 612-15, FIG. 6C). In some implementations, requesting a subsequent guidance step includes, for a respective guidance step that is currently presented, selecting a response from one or more selectable responses.

In accordance with a determination that a request for a subsequent guidance step is detected, the device requests a subsequent guidance step (702) (e.g., with guide traversal module 440 and/or 558). In accordance with a determination that a request to terminate the workflow is detected, the session is terminated (714).

Upon terminating the session, a report is generated (716) (e.g., by guide server 112 by using reports module 322). In some implementations, the report includes data representing a user's path through the interactive guide. Further, in some implementations, the report is generated automatically upon terminating the workflow, while in other implementations, the user manually chooses to generate the report (e.g., by selecting the generate transcript affordance 636). How the report is generated and what the report contains is discussed with respect to FIGS. 1 and 6E.

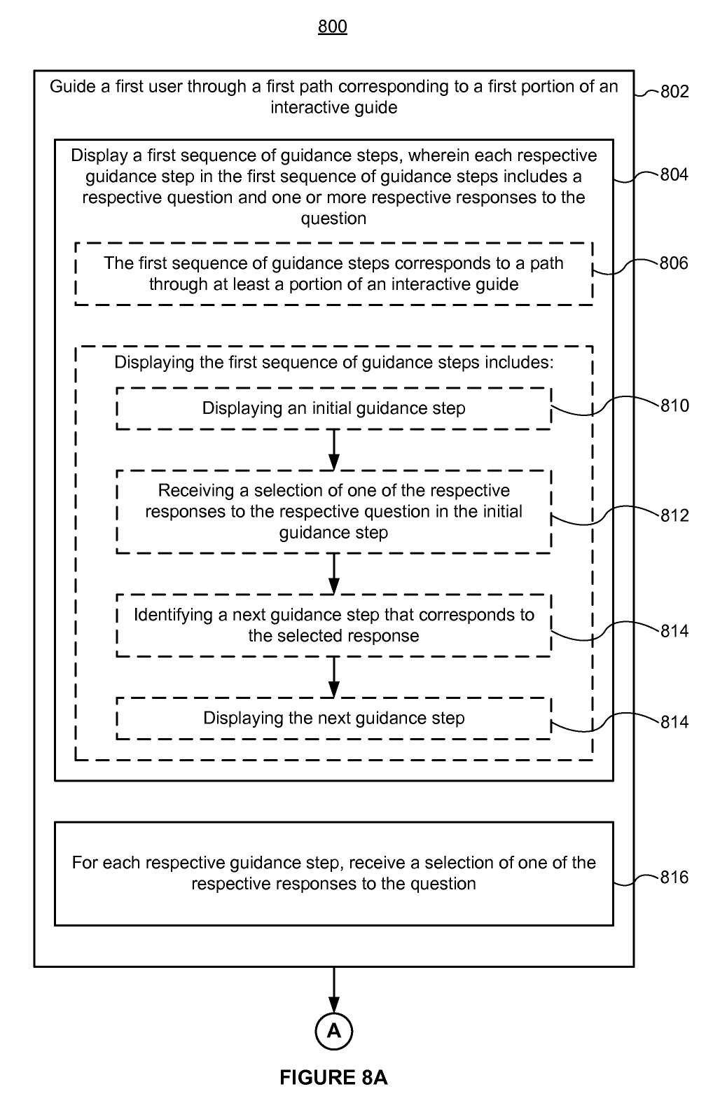

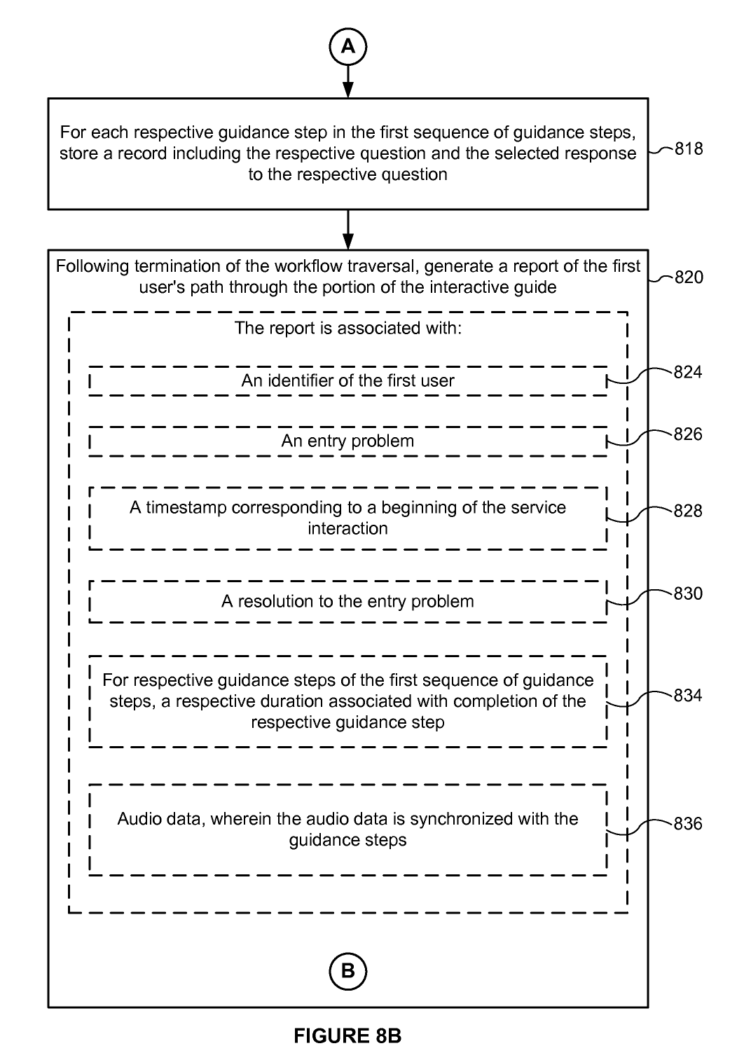

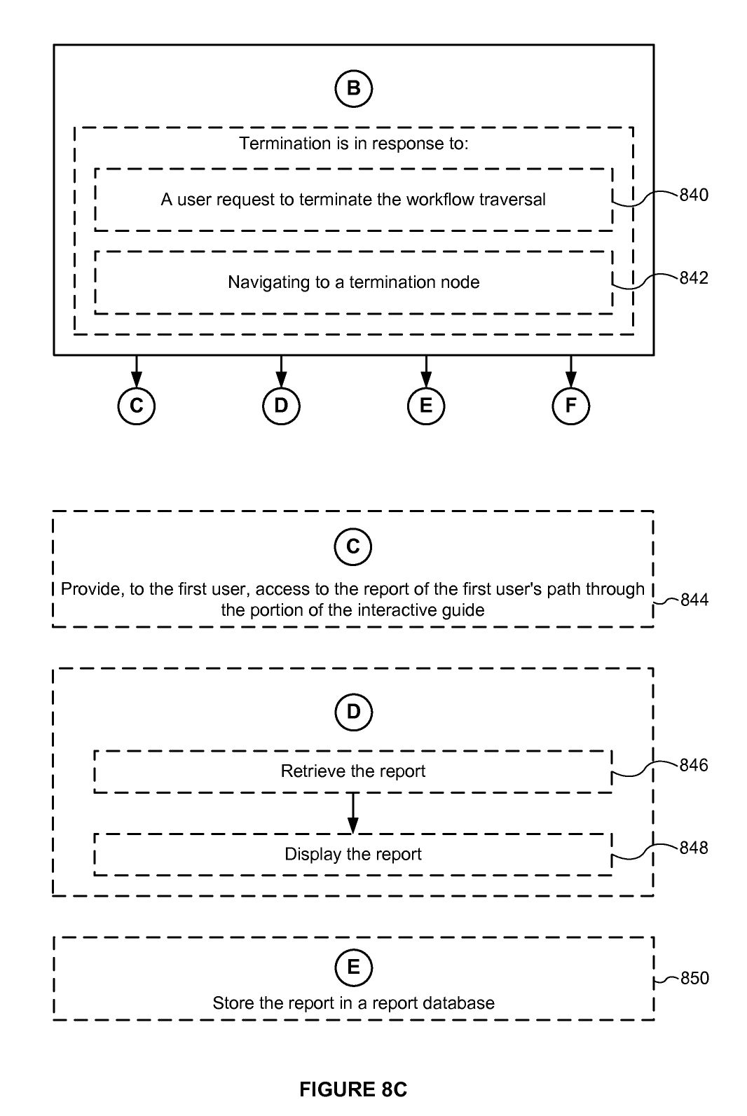

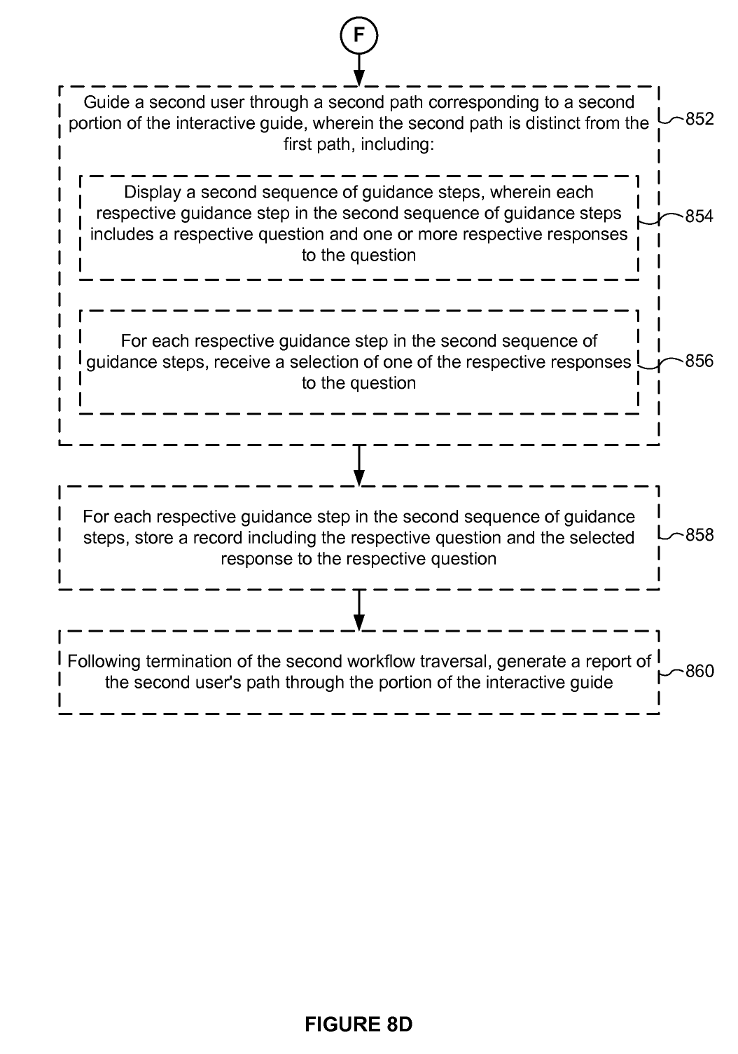

FIGS. 8A-8D are flow diagrams illustrating a method 800 of producing a record of a workflow traversal, in accordance with some implementations. The method 800 is performed, in some implementations, on a standalone device (e.g., client device 102-1 or enterprise device 104-1, where client device 102-1 or enterprise device 104-1 is acting as a standalone device). In some implementations, the method 800 is performed by a server device (e.g., guide server 112) that sends information to a client (e.g., client device 102-1 or enterprise device 104-1) for display. In some implementations, the method 800 is performed in part by a client (e.g., 102-1, 104-1) and in part by a server (e.g., guide server 112). For ease of reference, the method 800 will be described below as being performed simply by a device. It will be understood that, in various implementations, steps of the method 800 are performed by any of the aforementioned devices or combination of devices. FIGS. 8A-8D correspond to instructions stored in a computer memory or computer readable storage medium (e.g., memory 306 of the guide server 112, memory 406 of the client device 102-1, and/or memory 506 of the enterprise device 104-1).

The device guides a first user through a first path corresponding to a first portion of an interactive guide (802) (e.g., with end user/agent module 438 and/or 556), including displaying a first sequence of guidance steps, wherein each respective guidance step in the first sequence of guidance steps includes a respective question and one or more respective responses to the question (804) (e.g., with end user/agent module 438 and/or 556). In some implementations, the first user is an end user (e.g., end user 208, FIG. 2), or alternatively, an agent user (e.g., agent user 209). In addition to guidance steps 600, some implementations include termination steps (e.g., resolution node 612-1), which do not present a user with a question and do not require the user to select a response. Guidance steps, termination nodes, and other aspects of an interactive guide are described with respect to FIGS. 6A-6E.

In some implementations, the first sequence of guidance steps corresponds to a path through at least a portion of an interactive guide (806). In some implementations, each guidance step of the first sequence of guidance steps is linked to a plurality of subsequent guidance steps (e.g., resolution pathway beginning with guidance step 600-0, and further including guidance steps 600-2, 600-7, 600-8, and 600-9, FIG. 6B).

Furthermore, in some implementations, displaying the first sequence of guidance steps includes: displaying an initial guidance step (810) (e.g., guidance step 630-1, FIG. 6D); receiving a selection of one of the respective responses to the respective question in the initial guidance step (812) (e.g., response 634-1, FIG. 6D); identifying a next guidance step that corresponds to the selected response (814) (e.g., guidance step 630-2, FIG. 6D); and displaying the next guidance step (814) (e.g., guidance step 630-2, FIG. 6D). Displaying a first sequence of guidance steps is described with respect to the non-limiting example of FIG. 6D.

Guiding the first user through the first path corresponding to the first portion of an interactive guide further includes, for each respective guidance step, receiving a selection of one of the respective responses to the question (816) (e.g., with guide traversal module 440 and/or 558).

In FIG. 8B, for each respective guidance step in the first sequence of guidance steps, the device stores a record including the respective question and the selected response to the respective question (818) (e.g., with guide traversal module 440 and/or 558). In some implementations, the record is stored in a support database (e.g., incident database 122), or alternatively, in a local datastore (e.g., incident datastores 332, 450, and/or 566).

Following termination of the workflow traversal, the device generates a report of the first user's path through the portion of the interactive guide (820) (e.g., with reports module 322). As shown in FIG. 6D, in some implementations, the user may select the generate transcript affordance 636, which causes a user's traversal through the interactive guide to be terminated, and a report of the user's path through the interactive guide to be generated (e.g., report 640, FIG. 6E). In some implementations, the report includes: an identifier of the first user (824); an entry problem (826); a timestamp corresponding to a beginning of the service interaction (828); and/or a resolution to the entry problem (830). In some implementations, the report includes, for respective guidance steps of the first sequence of guidance steps, a respective duration associated with completion of the respective guidance step (834). Furthermore, in some implementations, the report includes audio data, wherein the audio data is synchronized with the guidance steps (836). An example of a generated report (e.g., report 640), and the various types of information it optionally includes, is described with respect to FIG. 6E.

In FIG. 8C, in some implementations, termination is in response to a user request to terminate the workflow traversal (840). In some implementations, termination is in response to navigating to a termination node (842). For example, while traversing an interactive guide, a user may navigate to a termination node (e.g., resolution 612-15, FIG. 6C), at which point the user is not presented with additional questions and does not select any additional responses.

Optionally, in some implementations, the device provides, to the first user, access to the report of the first user's path through the portion of the interactive guide (844) (e.g., transmitted by guide server 112 using reports module 322). In some implementations, providing access to the report includes providing a link to a file containing the report of the first user's path through the portion of the interactive guide. Additionally and/or alternatively, providing access to the report includes sending, to the first user (e.g., by e-mail), a file containing the report of the first user's path through the portion of the interactive guide.

Furthermore, in some implementations, the device retrieves (846) and displays (848) the report. FIG. 6E illustrates such an example. In some implementations, the device stores (850) the report in a report database. For example, as described with respect to FIGS. 1 and 2, a device (e.g., guide server 112) stores a report in a database (e.g., reports database 126).

In FIG. 8D, in some implementations, the device guides a second user through a second path corresponding to a second portion of the interactive guide (852) (e.g., with end user/agent module 438 and/or 556), wherein the second path is distinct from the first path, including: displaying a second sequence of guidance steps (854), wherein each respective guidance step in the second sequence of guidance steps includes a respective question and one or more respective responses to the question; and for each respective guidance step in the second sequence of guidance steps, receiving a selection of one of the respective responses to the question (856) (e.g., with guide traversal module 440 and/or 558). Furthermore, in these implementations, for each respective guidance step in the second sequence of guidance steps, the device stores a record including the respective question and the selected response to the respective question (858) (e.g., with guide traversal module 440 and/or 558). Furthermore, following termination of the second workflow traversal, the device generates a report of the second user's path through the portion of the interactive guide (860) (e.g., with guide traversal module 440 and/or 558). As described and illustrated in FIGS. 6B-6C, multiple paths can be traversed through an interactive guide by multiple different users (e.g., one resolution pathway including guidance steps 600-0, 600-2, 600-7, 600-8, 600-9, and resolution 612-1, and a second resolution including guidance steps 600-0, 600-3, 600-4, 600-5, and 600-6, and resolution 612-3).

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art so drawings herein do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method for producing a record of a workflow traversal, comprising:
at an electronic device with a processor and memory storing instructions for execution by the processor:
guiding a first user through a first path corresponding to a first portion of an interactive guide, including:
displaying a first sequence of guidance steps, wherein each respective guidance step in the first sequence of guidance steps includes a respective question and one or more respective responses to the question; and
for each respective guidance step, receiving a selection of one of the respective responses to the question;
for each respective guidance step in the first sequence of guidance steps, storing a record including the respective question and the selected response to the respective question; and
following termination of the workflow traversal, generating a report of the first user's path through the portion of the interactive guide.

2. The method of claim 1, wherein the first sequence of guidance steps corresponds to a path through at least a portion of an interactive guide.

3. The method of claim 1, further comprising providing, to the first user, access to the report of the first user's path through the portion of the interactive guide.

4. The method of claim 1, wherein the report includes:
an identifier of the first user;
an entry problem; and
a timestamp corresponding to a beginning of the service interaction.

5. The method of claim 4, wherein the report further includes a resolution to the entry problem.

6. The method of claim 1, wherein the report includes, for respective guidance steps of the first sequence of guidance steps, a respective duration associated with completion of the respective guidance step.

7. The method of claim 1, wherein the report includes audio data, wherein the audio data is synchronized with the guidance steps.

8. The method of claim 1, further comprising:
retrieving the report; and
displaying the report.

9. The method of claim 1, further comprising steps for producing a second workflow traversal, including:
guiding a second user through a second path corresponding to a second portion of the interactive guide, wherein the second path is distinct from the first path, including:
displaying a second sequence of guidance steps, wherein each respective guidance step in the second sequence of guidance steps includes a respective question and one or more respective responses to the question; and
for each respective guidance step in the second sequence of guidance steps, receiving a selection of one of the respective responses to the question;
for each respective guidance step in the second sequence of guidance steps, storing a record including the respective question and the selected response to the respective question; and
following termination of the second workflow traversal, generating a report of the second user's path through the portion of the interactive guide.

10. The method of claim 1, wherein displaying the first sequence of guidance steps includes:
displaying an initial guidance step;
receiving a selection of one of the respective responses to the respective question in the initial guidance step;
identifying a next guidance step that corresponds to the selected response; and
displaying the next guidance step.

11. The method of claim 1, further comprising storing the report in a report database.

12. The method of claim 1, wherein termination is in response to a user request to terminate the workflow traversal.

13. The method of claim 1, wherein termination is in response to navigating to a termination node.

14. An electronic device, comprising:
a processor; and
memory for storing one or more programs for execution by the processor, the one or more programs including instructions for:
guiding a first user through a path corresponding to a portion of an interactive guide, including:
displaying a first sequence of guidance steps, wherein each respective guidance step includes a respective question and one or more respective responses to the question; and
for each respective guidance step, receiving a selection of one of the respective responses to the question;
for each respective guidance step, storing a record including the respective question and the selected response to the respective question; and
following termination of the workflow traversal, generating a report of the first user's path through the portion of the interactive guide.

15. The electronic device of claim 14, wherein the report includes audio data, wherein the audio data is synchronized with the guidance steps.

16. The electronic device of claim 14, wherein displaying the first sequence of guidance steps includes:
displaying an initial guidance step;
receiving a selection of one of the respective responses to the respective question in the initial guidance step;
identifying a next guidance step that corresponds to the selected response; and
displaying the next guidance step.

17. A non-transitory computer readable storage medium, storing one or more programs for execution by one or more processors, the one or more programs including instructions for:
guiding a first user through a path corresponding to a portion of an interactive guide, including:
displaying a first sequence of guidance steps, wherein each respective guidance step includes a respective question and one or more respective responses to the question; and
for each respective guidance step, receiving a selection of one of the respective responses to the question;
for each respective guidance step, storing a record including the respective question and the selected response to the respective question; and
following termination of the workflow traversal, generating a report of the first user's path through the portion of the interactive guide.

18. The non-transitory computer readable storage medium of claim 17, wherein the report includes, for respective guidance steps of the first sequence of guidance steps, a respective duration associated with completion of the respective guidance step.

19. The non-transitory computer readable storage medium of claim 17, wherein the report includes audio data, wherein the audio data is synchronized with the guidance steps.

20. The non-transitory computer readable storage medium of claim 17, wherein displaying the first sequence of guidance steps includes:
displaying an initial guidance step;
receiving a selection of one of the respective responses to the respective question in the initial guidance step;
identifying a next guidance step that corresponds to the selected response; and
displaying the next guidance step.
